(19) United States
(12) Patent Application Publication
(10) Pub. No.: US 2008/0288485 A1
(43) Pub. Date: Nov. 20, 2008

(54) STANDARDS-BASED LEARNING SYSTEMS AND METHODS

(76) Inventors: William L. Lager, Columbus, OH (US); Jeremy J. Margeson, Columbus, OH (US)

Correspondence Address: CALFEE HALTER & GRISWOLD, LLP, 800 SUPERIOR AVENUE, SUITE 1400, CLEVELAND, OH, 44114, US

(21) Appl. No.: 12/116,344

(22) Filed: May 7, 2008

Related U.S. Application Data
(60) Provisional application No. 60/938,637, filed on May 17, 2007.

(51) Int. Cl. G06F 7/06; G06F 17/30

(52) U.S. Cl. 707/5; 707/E17.008

(57) ABSTRACT

A user creating or modifying a lesson in an LMS can indicate a standard, such as a state-defined educational standard, for which additional content is wanted and the LMS will automatically retrieve content from an external resource, such as an LOR, that corresponds to the standard.

### RELATED APPLICATION

The present application is being filed as a non-provisional patent application claiming priority/benefit under 35 U.S.C. § 119(e) from U.S. Provisional Patent Application No. 60/938,637 filed on May 17, 2007, which is incorporated herein by reference.

### FIELD

The invention relates generally to systems and methods for on-line learning and, more particularly, to systems and methods for bridging learning management systems and learning object repositories.

### BACKGROUND

A learning management system (LMS) 100 uses software and hardware (e.g., logic 102) to implement a system for planning, delivering and managing learning events within an institution (e.g., corporation, school), including on-line, virtual classroom and instructor-led courses. The LMS 100 can support, for example, the management of learners, courses, instructors and facilities, as well as the generation of related reports; messaging and notifications; a course calendar; and learner assessment and testing. The content used by instructors within the LMS 100 can come from the LMS 100 itself, in the form of internal content 104, or can come from a source external to the LMS 100, such as a learning object repository (LOR) 106.

The LOR 106 is a collection of learning objects 108 that can be used by instructors to meet their educational needs, for example, within the LMS 100. A learning object 108 is any resource (usually digital) that can be used to support learning and, in particular, technology-supported learning. For example, the learning objects 108 can include text files, video clips, audio clips, slide presentations, computer games, web pages, etc. Furthermore, a learning object 108 can include a pointer (e.g., a URL) to content physically located outside the LOR 106.

Each learning object 108 includes an external component of information in the form of metadata 110 that helps with its identification, storage and recovery. In this manner, the metadata 110 supports the discoverability, the reusability and the interoperability of the learning objects 108. The metadata 110 can adhere to a data model (e.g., encoded in XML). For example, the IEEE 1484.12.1 Standard for Learning Object Metadata, which is herein incorporated by reference, is a 2002 open standard for the description of learning objects, such as learning objects 108. Examples of relevant attributes of the learning objects 108 (described by the metadata 110) can include the type of object, the author, the owner, the terms of distribution, lifecycle information, as well as pedagogical attributes, such as teaching or interaction style.

The No Child Left Behind Act of 2002 is an example of a federal law relating to the theories of standards-based education reforms. These theories are based on the belief that high expectations and setting of goals will result in success for all students. The Act requires states to develop assessments in basic skills to be given to all students in certain grades, if those states are to receive federal funding for schools. Each state sets its own learning standards that all children living in the state are expected to meet.

In particular, the Act requires periodic assessment of all students against state standards to insure that a school, district and the state are making progress toward the Act's general proficiency goals. These assessments frequently take the form of multiple-choice standardized tests. Accordingly, many educators base their curriculums, in whole or in part, on these state standards and their corresponding assessment mechanisms.

Thus, for educators and institutions using an LMS, such as the LMS 100, it is useful to access content, such as the learning objects 108 in the LOR 106, based on the relevant standards of a particular state. Conventionally, while planning or otherwise creating a lesson in the LMS, an educator would need to manually look up an appropriate state standard; leave the LMS; access an LOR or other content resource; look for content that matches the state standard in the LOR; retrieve the desired content, if any is found, from the LOR; leave the LOR; access the LMS; and then copy or otherwise import the content into the LMS. Consequently, there is an unmet need for an LMS that can automatically query an LOR for content based on a state standard selected from within the LMS.

### SUMMARY

In view of the above, it is an exemplary aspect to provide an LOR including a plurality of learning objects, wherein each learning object is mapped to at least one state standard, such that a known learning object with a corresponding state standard can be used to retrieve other learning objects mapped to the same state standard.

It is another exemplary aspect to provide an LMS that lists a plurality of state standards and, in response to a learning object with a corresponding state standard being selected from within the LMS, lists a plurality of learning objects corresponding to the same state standard.

It is yet another exemplary aspect to provide a system for importing content into an LMS, wherein the content is retrieved from an LOR based on a state standard of a learning object displayed in the LMS.

It is still another exemplary aspect to provide a method of retrieving content from an LOR based on a state standard corresponding to content displayed within an LMS.

Numerous additional advantages and features will become readily apparent from the following detailed description of exemplary embodiments, from the claims and from the accompanying drawings.

### BRIEF DESCRIPTION OF THE DRAWINGS

The invention as well as embodiments and advantages thereof are described below in greater detail, by way of example, with reference to the drawings wherein like reference numbers denote like elements and in which:

FIG. 1 is a diagram of a conventional LMS and a conventional LOR.

FIG. 2 is a diagram of a system that interfaces an LMS and an LOR, according to one exemplary embodiment.

FIGS. 3A-3C show learning objects associated with state standards, according to one exemplary embodiment.

FIG. 4 is a diagram of a system that interfaces an LMS and an LOR, according to one exemplary embodiment.

FIG. 5 is a diagram of a list of state standards corresponding to a specified educational topic, according to one exemplary embodiment.

FIG. 6 is a diagram of a list of learning objects found in an LOR based on a specified state standard, according to one exemplary embodiment.

FIG. 7 is a flowchart of a method for retrieving content from an LOR based on a state standard selected from within an LMS, according to one exemplary embodiment.

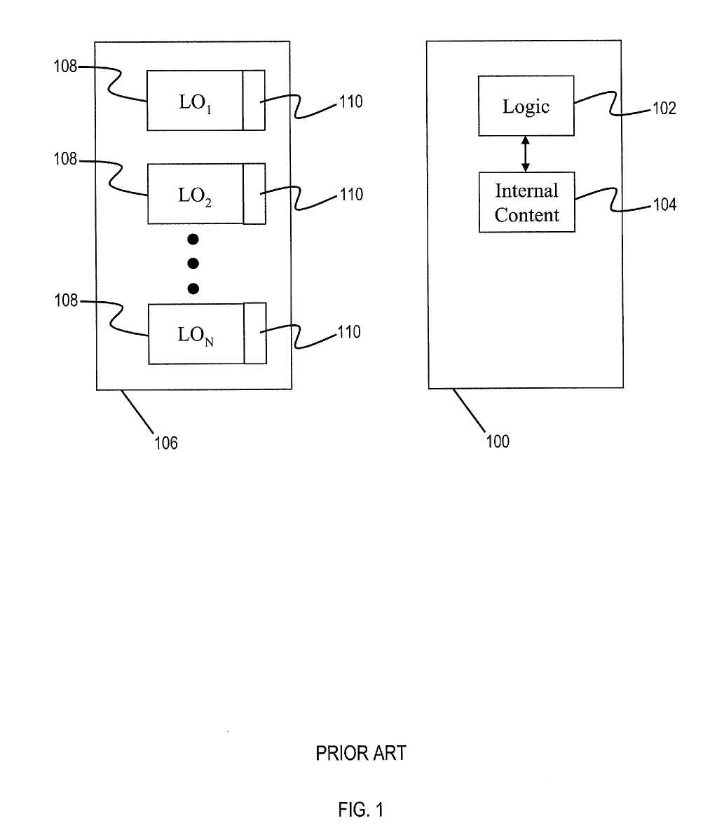

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

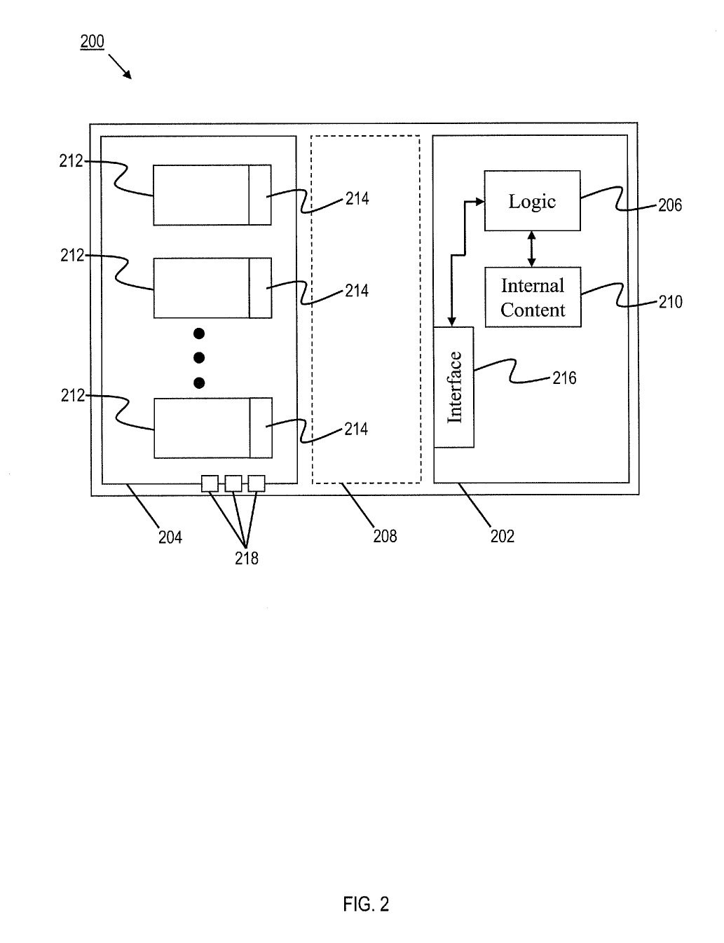

As shown in FIG. 2, a system 200, according to one exemplary embodiment, integrates an LMS 202 and at least one LOR 204 by mapping the content associated with the LOR 204 to a plurality of state standards predefined by a particular state. The LMS 202 has logic 206, which can include software and/or hardware, that acts as a bridge 208 for allowing a user of the LMS 202 to access the content in the LOR 204 from within the LMS 202 based on the state standards. In one exemplary embodiment, the bridge 208 is implemented as a set of software functions/routines forming part of the LMS 202. In one exemplary embodiment, the bridge 208 is implemented as a plug-in or add-on module for the LMS 202.

In addition to any internal content 210, the LMS 202 has access to content in the LOR 204. The content in the LOR 204 can be stored as a plurality of learning objects 212, with each learning object 212 having associated metadata 214 for storing various attributes of the learning object 212. In one exemplary embodiment, the metadata 214 includes attributes defining a title, a subject, relevant keywords, an abstract, a type or format of the learning object, a publication date, a publisher, an author, rights information and a unique identifier. The LMS 202 includes an interface 216 which the logic 206 can use to access the disparate content types represented by the learning objects 212. Likewise, the LOR 204 includes one or more application program interfaces (APIs) 218 for supporting access by the interface 216 to the different types of the learning objects 212 (e.g., .pdf files, .wmv files, .mp3 files, .doc files, .jpg files).

The metadata 214 can also be used to map each learning object 212 to one or more state standards. In general, the state standards are clearly defined statements and/or illustrations of what all applicable students, teachers, schools and districts are expected to know and be able to do. For example, a state standard for a given grade level could be “identify own name in print.” As another example, a state standard for the grade level could be “recognize that words are made up of letters (e.g., c-a-t).” By mapping the learning objects 212 in the LOR 204 to the various state standards defined by a particular state, the learning objects form a hierarchy. This hierarchy can be defined by other criteria as well, such as grade level (e.g., pre-K, 1st, 2nd) and subject matter (e.g., reading, writing, mathematics).

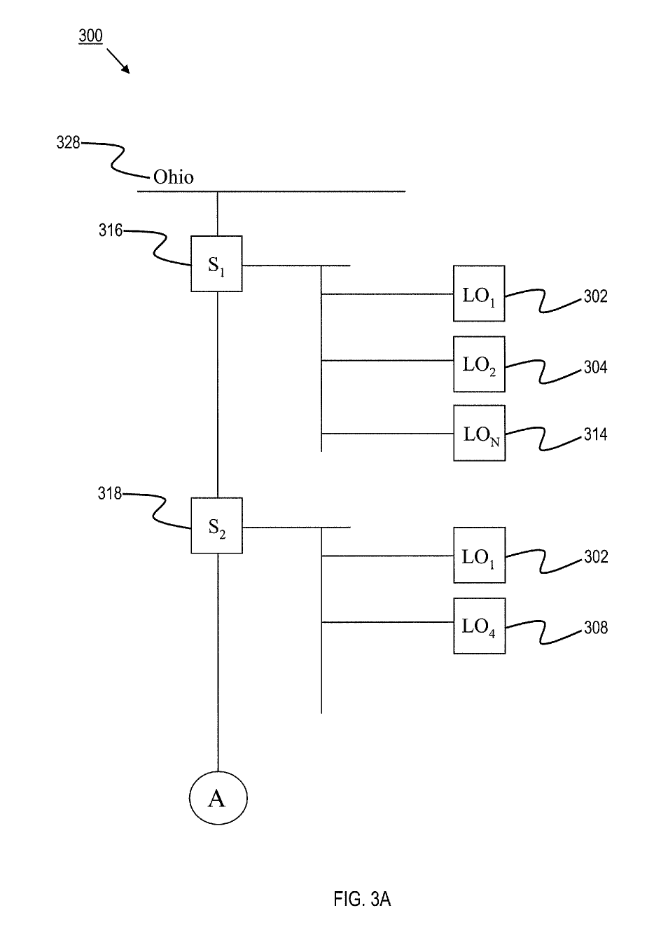

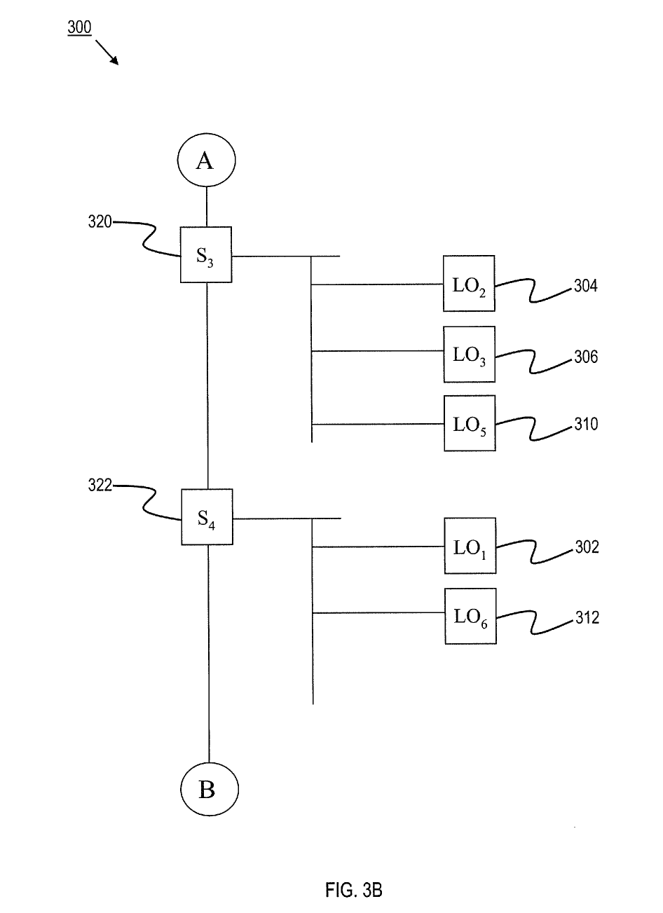

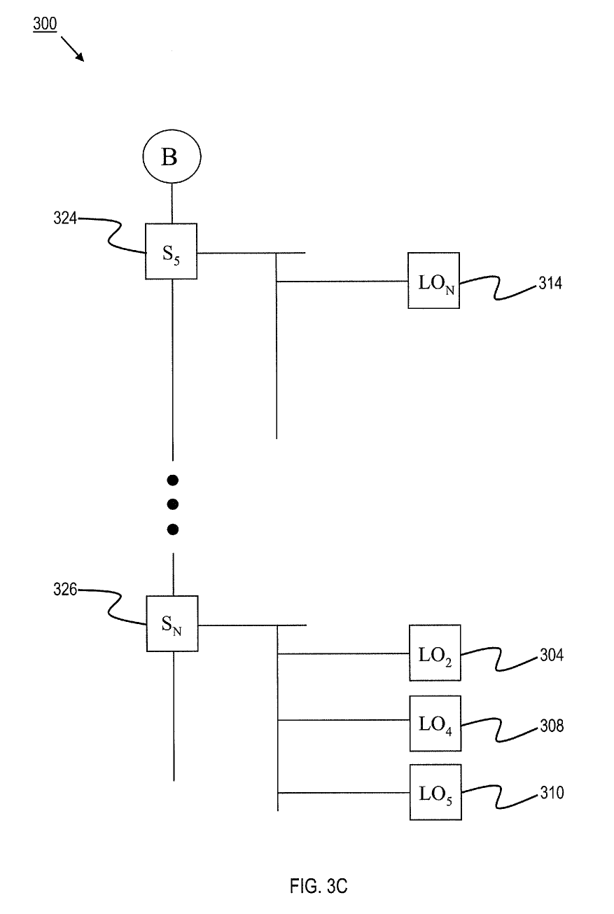

An LOR (e.g., LOR 204), according to one exemplary embodiment, includes a set of learning objects {LO₁ 302, LO₂ 304, LO₃ 306, LO₄ 308, LO₅ 310, LO₆ 312, . . . , LO_{N} 314} mapped to a set of state standards {S₁ 316, S₂ 318, S₃ 320, S₄ 322, S₅ 324, . . . , S_{N} 326} defined for a particular state 328, such as Ohio. The mapping of the learning objects to the state standards of the state 328 creates a hierarchy 300, as shown in FIGS. 3A-3C. In the hierarchy 300, a first state standard S₁ 316 is associated with learning objects LO₁ 302, LO₂ 304 and LO_{N} 314; a second state standard S₂ 318 is associated with learning objects LO₁ 302 and LO₄ 308; a third state standard S₃ 320 is associated with learning objects LO₂ 304, LO₃ 306 and LO₅ 310; a fourth state standard S₄ 322 is associated with learning objects LO₁ 302 and LO₆ 312; a fifth state standard S₅ 324 is associated with learning object LO_{N} 314; and an Nth state standard S_{N} 326 is associated with learning objects LO₂ 304, LO₄ 308 and LO₅ 310. In one exemplary embodiment, there is at least one learning object in the LOR for every state standard of the particular state 328.

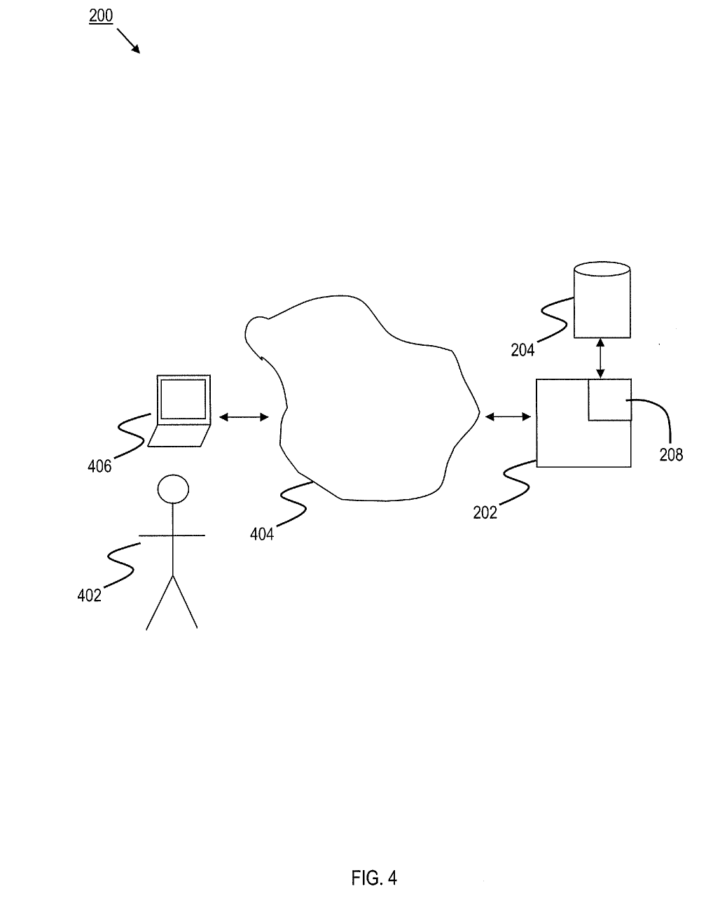

As shown in FIG. 4, an implementation of the system 200, according to one exemplary embodiment, allows a user 402 (e.g., an educator) to access the LMS 202 over a network 404 using a computer 406. In one exemplary embodiment, the computer 406 includes a Web browser for accessing the LMS 202 over the Internet as the network 404.

As an educator, the user 402 must insure that his or her students meet all of the requisite state standards defined for the grade level of the students. As the user 402 prepares a lesson within the LMS 202, the content available to the user 402 may be deemed deficient (e.g., inadequate and/or insufficient). For example, if the user 402 looks up a particular state standard needing to be taught, the state standard may reference a portion of a text book for a subject (e.g., geometry) relating to the state standard. The text book might not have adequate or sufficient content to support the user 402 in teaching the state standard. Consequently, the user 402 must look elsewhere for content to use instead of or in addition to the text book in teaching the state standard.

When using conventional on-line search tools (e.g., an Internet search using a Web browser, an LOR search using an LOR interface) to find content, the search queries may be difficult and time consuming to formulate. Furthermore, it may be difficult to determine if a search query returns any content that corresponds to a particular state standard. Further still, even if a search query returns content corresponding to the particular state standard, the relevant content may be obscured by a large amount of extraneous content that the search query returned as well. Further still, the accuracy of the content may be in question if the content comes from a source lacking strict standards and oversight on the quality of its content.

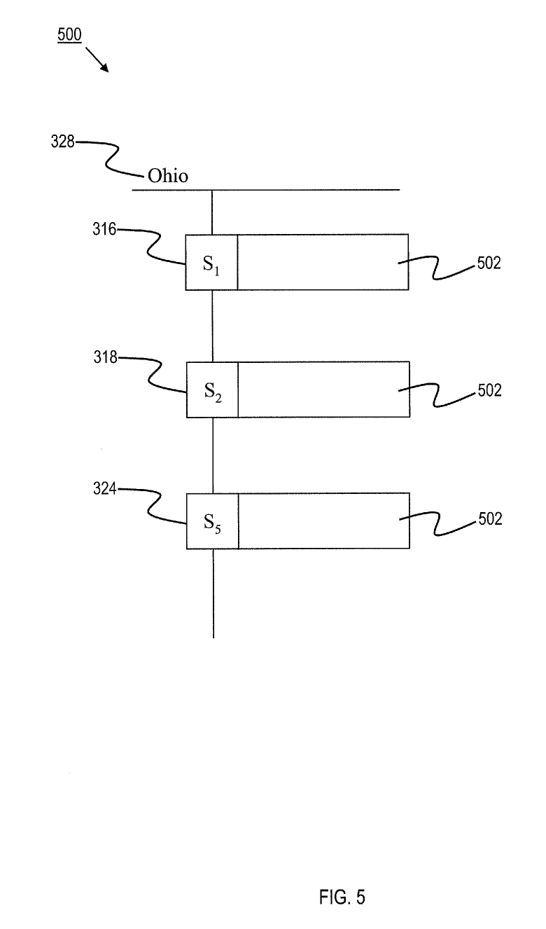

To avoid or otherwise mitigate these problems, the system 200 uses the bridge 208 to facilitate accessing the LOR 204 from within the LMS 202 based on the state standards defined for a state. Accordingly, if the user 402 preparing the lesson within the LMS 202 determines that additional content is necessary, the user 402 can browse to a desired state standard from within the LMS 202 that relates to the lesson being planned. For example, by specifying the relevant state 328 (e.g., Ohio) and subject matter, category or topic (e.g., mathematics, geometry, calculating area), the user 402 is presented with a list 500 of corresponding state standards (e.g., S₁ 316, S₂ 318 and S₅ 324), as shown in FIG. 5. In one exemplary embodiment, the user 402 can specify the relevant subject matter, category or topic by selecting content displayed within the LMS 202 (e.g., within a classroom defined in the LMS 202), wherein the bridge 208 then determines the state standards corresponding to the selected content and constructs the list 500. One of ordinary skill in the art will appreciate that the LMS 202 can present the list 500 on a display of the computer 406 of the user 402 in many different formats. In one exemplary embodiment, the user 402 can enter additional criteria to reduce the number of state standards in the list 500.

Each of the state standards presented in the list 500 can include other identifying informing, such as a narrative indicator 502 corresponding to each of the state standards. For example, the state standard S₁ 316 could have an indicator 502 that reads “count to 10 in the context of daily activities and play (e.g., number songs);” the state standard S₂ 318 could have an indicator 502 that reads “demonstrate one-to-one correspondence when counting objects (e.g., give one cookie to each child in group);” and the state standards S₅ 324 could have an indicator 502 that reads “construct two sets of objects, each containing the same number of objects (e.g., 5 crayons and 5 blocks).” The indicators 502 could include additional information, such as benchmark information, relating to each of the state standards. The indicators 502 can help the user 402 determine an appropriate one of the state standards from the list 500. In one exemplary embodiment, the user 402 can navigate this list of state standards 500 in the LMS 202 until a state standard desired by the user 402 (e.g., S₂ 318) is found. In one exemplary embodiment, the aforementioned selection of the content displayed within the LMS 202 by the user 402 results in the automatic selection of all state standards mapped to the selected content being deemed the desired state standards.

Once the desired state standard S₂ 318 is selected by the user 402, the bridge 208 accesses the LOR 204 to retrieve all of the learning objects 212 associated with the state standard S₂ 318. In one exemplary embodiment, the bridge 208 determines which learning objects 212 are associated with the state standard S₂ 318 by parsing the metadata 214 of the various learning objects 212 in the LOR 204. In this manner, the bridge 208 retrieves the relevant learning objects LO₁ 302 and LO₄ 308 from the LOR 204 without requiring that the user 402 formulate a specific search query. Furthermore, each of the retrieved learning objects LO₁ 302 and LO₄ correspond to the selected state standard S₂ 318, with no extraneous content being delivered. In one exemplary embodiment, the LOR 204 is managed or otherwise controlled, such that the accuracy of the content (i.e., the learning objects 212) in the LOR 204 is insured.

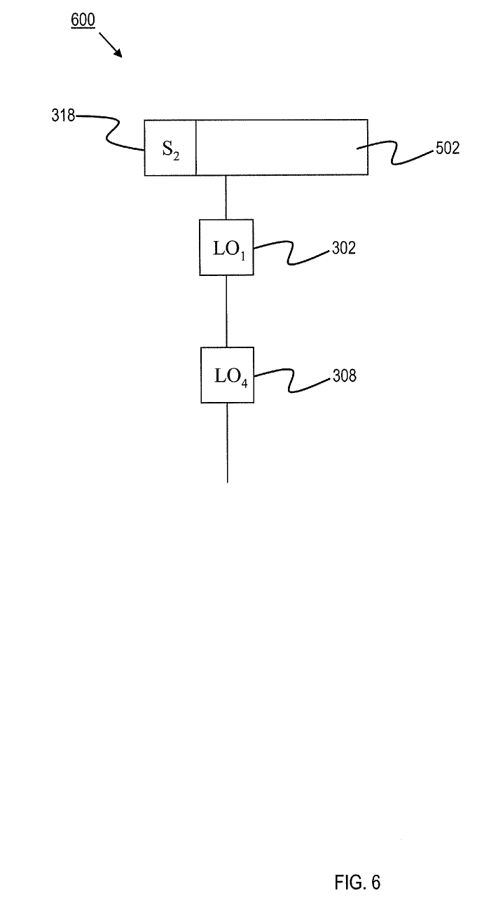

After the bridge 208 retrieves the learning objects LO₁ 302 and LO₄ 308 associated with the state standard S₂ 318, the user 402 is presented with a list 600 of the retrieved learning objects LO₁ 302 and LO₄ 308 by the LMS 202, as shown in FIG. 6. The user 402 can then select one of the desired learning objects LO₁ 302 and LO₄ 308 from the list 600. In one exemplary embodiment, the user 402 can preview the content of any of the learning objects 212 in the list 600 prior to selecting the desired learning object (e.g., LO₄ 308). Because the list 600 of learning objects 212 is displayed within the LMS 202, the user 402 can readily insert (e.g., via a drag-and-drop operation) the selected learning object LO₄ 308 into the lesson being created or otherwise modified within the LMS 202. If more than one learning object 212 is desired from the list 600, then the user 402 can repeat the insertion operation for each desired learning object 212. Thus, the system 200 allows the user 402 to readily create and modify lessons within the LMS 402 that include content located outside the LMS 402.

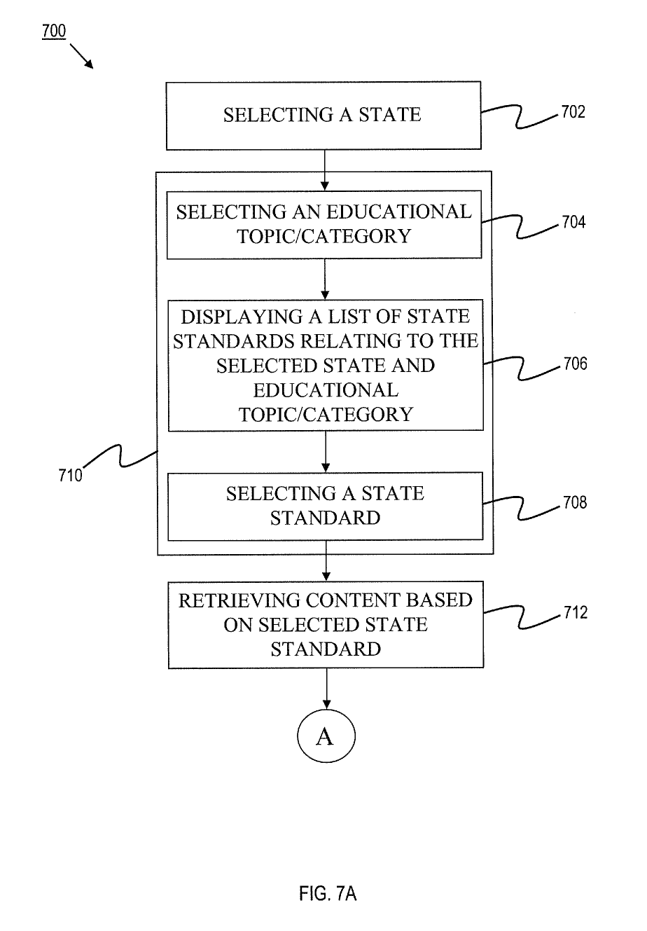

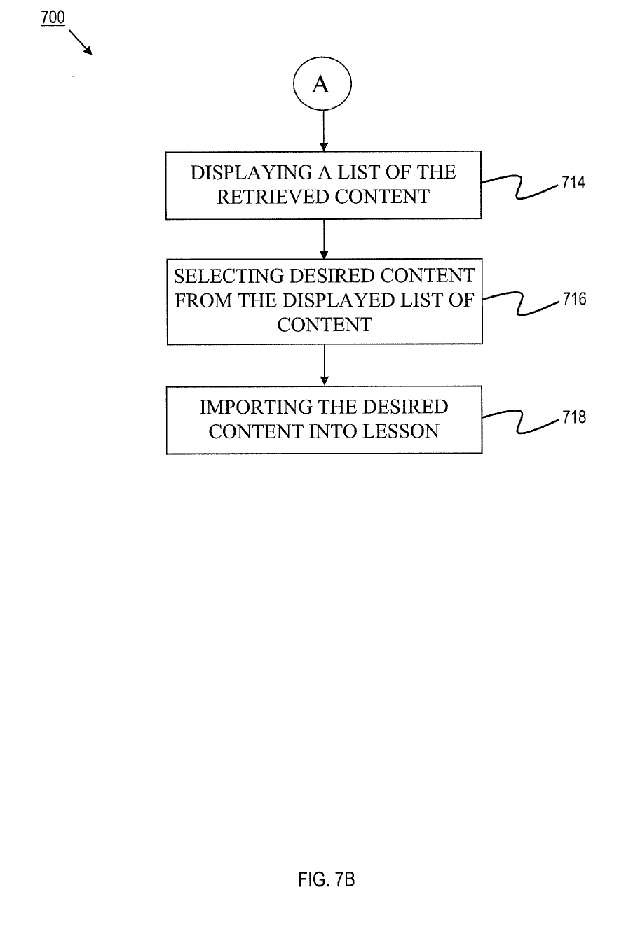

As shown in FIG. 7, a method 700, according to one exemplary embodiment, allows a user (e.g., user 402) to retrieve content (e.g., learning objects 212) from a content source (e.g., LOR 204) based on a standard (e.g., a predefined state educational standard) selected from within a learning system or program (e.g., LMS 202).

In one exemplary embodiment, the user selects a state of interest in step 702. The state of interest generally can be set once (e.g., in a profile of the user 402) and assumed to be static unless changed by the user. Only those standards defined by the selected state are deemed applicable. Then, the user selects an educational topic/category in step 704, which provides additional information for determining which of the state's standards are applicable. For example, the user can select the educational topic/category by selecting content (e.g., a learning object 212) displayed within the learning system or program (e.g., LMS 202). From these choices input by the user, a list of state standards relating to the selected state and topic/category are displayed in step 706. For example, the list of state standards is displayed in an LMS in which the user is creating or modifying a lesson.

From the displayed list of state standards, the user selects a state standard of interest in step 708. In one exemplary embodiment, steps 702, 704 and 706 are optional and the user can directly select the state standard of interest by selecting content (e.g., a learning object 212) displayed within the learning system or program (e.g., LMS 202), represented as step 710. From the selected content, the state standard or standards mapped thereto are determined to be the state standard of interest in step 710. Once the state standard of interest is selected, the state standard of interest is used to retrieve content (e.g., one or more learning objects) from a content source such as an LOR in step 712. A list of the retrieved learning objects is displayed in step 714. For example, the list of the retrieved learning objects is displayed in the aforementioned LMS.

From the list of learning objects, the user selects a learning object of interest in step 716. Once the learning object of interest is selected by the user, the user can move (e.g., via a drag-and-drop operation) the learning object of interest into the lesson being created or modified in step 718. If the user is interested in multiple learning objects from the list displayed in step 714, steps 716 and 718 can be repeated as necessary. In one exemplary embodiment, the selection of the learning object of interest in step 716 automatically imports the learning object of interest into the lesson, such that step 718 is unnecessary.

In view of the above, the user can create or otherwise modify a lesson from within the LMS to include one or more learning objects automatically retrieved from the LOR based on a state standard selected by the user. Thus, the user can access content within the LOR without leaving the LMS. In one exemplary embodiment, a traditional interface to the LOR is also available to the user.

Some exemplary features of the standards-based systems and methods disclosed herein include: (1) allowing the user to view the standards to which a learning object of interest is mapped; (2) allowing the user to change the state of interest to view the standards to which the learning object of interest is mapped for the newly selected state; (3) allowing the user to view the metadata for the learning object of interest from within an LMS; (4) allowing the user to find other learning objects mapped to the same standards as a learning objected selected from within the LMS; (5) allowing the user to preview retrieved learning objects from within the LMS; (6) allowing the user to readily insert one or more retrieved learning objects into a lesson or other management item within the LMS; (7) allowing the user to create a new item in an LOR that is mapped to the same standards as an existing learning object in the LMS; (8) allowing the user to search for learning objects in the LOR, based on any subject or standard, without leaving the LMS; and (9) allowing the user to create a new item in the LOR, based on any subject or standard, without leaving the LMS.

The above description of specific embodiments has been given by way of example. From the disclosure given, those skilled in the art will not only understand the general inventive concept and its attendant advantages, but will also find apparent various changes and modifications to the structures and methods disclosed. For example, although the above exemplary embodiments are directed to mapping content in an LOR to predefined state educational standards, the general inventive concept encompasses mapping content in an external source to any predefined standards (e.g., corporate compliance standards), so that an LMS can automatically retrieve content from the external source based on a selected one of the predefined standards. It is sought, therefore, to cover all such changes and modifications as fall within the spirit and scope of the general inventive concept, as defined by the appended claims and equivalents thereof.

What is claimed is:

1. A system for accessing content external to a learning management system from within the learning management system, the system comprising:
a content source for storing a plurality of content objects;
a server for hosting the learning management system; and
a client operable to access the server to interact with the learning management system,
wherein the server is external to the content source and is operable to access the content source to retrieve the content objects;
wherein each of the content objects is mapped to a related standard from a plurality of predefined standards;
wherein if the client is used to select a particular content object displayed within the learning management system, the server automatically determines the related standard to which the particular content object is mapped and retrieves all of the content objects mapped to the same related standard from the content source.

2. The system of claim 1, wherein the content source is a learning object repository.

3. The system of claim 1, wherein at least one of the content objects is a link to content stored outside of the content source.

4. The system of claim 3, wherein the link is a uniform resource locator.

5. The system of claim 1, wherein after the server retrieves all of the content objects mapped to the same related standard from the content source, the server displays the content objects at the client.

6. The system of claim 1, wherein the plurality of predefined standards are educational standards.

7. The system of claim 6, wherein the educational standards are defined by at least one state agency.

8. The system of claim 1, wherein the client includes a Web browser for communicating with the server over the Internet.

9. A method of accessing content external to a learning management system from within the learning management system, the method comprising:
selecting content of interest displayed within the learning management system;
determining a predefined standard to which the content of interest is mapped;
retrieving data mapped to the predefined standard from a content source external to the learning management system; and
displaying the data in the learning management system.

10. The method of claim 9, further comprising providing identifying information.

11. The method of claim 10, wherein the identifying information is a state.

12. The method of claim 9, wherein the predefined standard is an educational standard.

13. The method of claim 12, wherein the educational standard is defined by at least one state agency.

14. The method of claim 9, wherein the content source is a learning object repository.

15. The method of claim 14, wherein the data is at least one learning object.

16. The method of claim 14, wherein the data is a plurality of learning objects.

17. The method of claim 16, further comprising selecting a learning object of interest from the learning objects.

18. The method of claim 17, further comprising previewing the learning object of interest.

19. The method of claim 17, further comprising importing the learning object of interest into a lesson defined in the learning management system.

20. An article of manufacture comprising a computer-readable medium tangibly embodying instructions readable by a computer for performing a method of accessing content external to a learning management system from within the learning management system, the method comprising:
selecting content of interest displayed within the learning management system;
determining a predefined standard to which the content of interest is mapped;
retrieving data mapped to the predefined standard from a content source external to the learning management system; and
displaying the data in the learning management system.
